(19) United States
(12) Patent Application Publication
(10) Pub. No.: US 2018/0293336 A1
(43) Pub. Date: Oct. 11, 2018

(54) FORECASTING ULTIMATE RECOVERY OF OIL AND OIL PRODUCTION FOR A MULTIPLY-FRACTURED HORIZONTAL WELL

(71) Applicant: Qingfeng Tao, Katy, TX (US)

(72) Inventor: Qingfeng Tao, Katy, TX (US)

(21) Appl. No.: 15/481,127

(22) Filed: Apr. 6, 2017

(51) Int. Cl. G06F 17/50; E21B 47/06; E21B 43/00; E21B 47/10; G06F 17/10

(52) U.S. Cl. CPC G06F 17/5009; E21B 47/06; G06F 17/10; E21B 47/10; E21B 43/00

(57) ABSTRACT

A system and method to forecast oil production and estimated ultimate recovery of oil from a multiply-fractured horizontal shale oil well. The method includes determining oil flow behavior of the oil well during linear stage flow and pseudo boundary stage flow of a well. Oil production forecasts and estimated ultimate recovery are determined based on the flow behaviors of the well and historical oil production rate data obtained from sensors disposed in or around the well. The system includes said sensor for measuring properties of the well and, optionally, a computer processor for executing the method.

### BACKGROUND OF THE DISCLOSURE

### 1. Field of Disclosure

The present disclosure relates to a system and method for forecasting recovery in oil wells, and specifically for forecasting recovery in multiply-fractured horizontal wells.

### 2. Description of the Related Art

Accurate forecasts and estimated ultimate recovery (EUR) of the producing oil wells are important in estimating the reserve and economic value of a producing oil field. One method for forecasts and EUR ultimate recovery in oil wells is Decline Curve Analysis (DCA), which has been widely used in the oil industry. The DCA method involves performing a curve fit of the historical oil production rate and extrapolating the fitted trend of the oil production rate to forecast the future oil production rate. The curve fit in DCA may be harmonic, exponential, or hyperbolic based on assumptions made during the analysis; thus the same historical oil production rate data may result in significant variation in the forecasted oil production rates. Generally, the DCA method works for wells during steady state or pseudo steady state stage.

The recent boom in shale oil production brings with it the challenge of accurately forecasting the oil production for multiply-fractured horizontal shale oil wells. Multiply-fractured horizontal shale oil wells are different from the wells drilled in a conventional reservoir. Firstly, the shale reservoir has very low permeability relative to conventional reservoirs. The permeability of a shale reservoir is in the nanodarcy range, while a conventional reservoir has considerably higher permeability. Typically conventional reservoirs have permeabilities ranging from several millidarcy to several Darcy. Secondly, it will take several months to several years for the shale wells to reach a pseudo steady state stage. The pseudo steady state is when oil is flowing into a fracture of a multiply-fractured horizontal oil well, and the flow of the oil into the fracture is limited by the behavior of oil flow due to the presence of additional flow paths into adjacent fractures. It is not reliable to forecast the production by the DCA method from the early historical oil production rate because the production rate and the pressure are still undergoing unstable decline before the oil flow is limited by the adjacent fractures.

In addition, the rate transient analysis (RTA) method and the numerical reservoir simulation method have been used to forecast oil production and EUR. However, both methods require a lot of input data (e.g., reservoir porosity, reservoir permeability, reservoir thickness, reservoir fluid properties, completion design, etc.). Usually not all of these data are available for producing wells due to economic and/or technical limitations. Some data may only be obtained during the exploratory phase of oil production, and, if not collected during that phase, are unavailable once the well has entered the production phase. In addition, the uncertainty of each input parameter brings additional uncertainty to forecasted results.

A shortcoming of the DCA method is that flow behavior cannot be accurately predicted by only plotting the oil production rate versus the real production time when the production rate and pressure are varying in the early stage of a shale oil well. Another shortcoming is that the DCA method can be subjective based on the curve fitting method selected.

A shortcoming of the RTA and numerical reservoir simulation methods is that both of these methods require a lot of different data (e.g., reservoir porosity, reservoir permeability, reservoir thickness, reservoir fluid properties, completion design, etc.), where some data are either costly to obtain or not available for the producing wells.

The clear characteristics of flow behavior can be observed when the pressure normalized rate (PNR) is plotted versus the material balance time. Some methods have been developed to use the PNR trend to forecast oil production. But those methods only fit one trend for the PNR. Therefore, a method is invented to use the two trends of the flow stage of shale oil well to forecast oil production and EUR.

Therefore, there is a need in the industry to develop an accurate and efficient method to forecast the oil production and EUR for the multiply-fractured shale oil wells.

### BRIEF SUMMARY OF THE DISCLOSURE

In aspects, the present disclosure is related to a system and method for forecasting oil recovery, and, in particular, forecasting oil recovery in multiply-fractured horizontal oil wells.

One embodiment according to the present disclosure includes a method for forecasting oil recovery from a first multiply-fractured horizontal oil well, the method comprising: calculating a pressure drop; a pressure normalization rate; a cumulative oil production, and a material balance time for the well using historical oil production rate data, bottom hole pressure data, and an initial reservoir pressure for the first well; generating a pressure normalization rate-material balance time curve of the historical oil production rate data; determining if pseudo boundary flow stage behavior has started for the first well based on the pressure normalization rate-material balance time curve of the historical oil production rate data; where if the pseudo boundary flow stage behavior has started: generating a pressure normalization rate trend for a pseudo boundary flow stage of the first well; and determining at least one of: an estimated ultimate recovery and a forecast of oil production for the first well; and where if the pseudo boundary flow stage behavior has not started: generating a pressure normalization rate trend for a linear flow stage of the first well; obtaining offset well historical oil production rate data, offset well bottom hole pressure data, and offset well initial reservoir pressure data from a second well, offset from the first well; calculating an offset well pressure drop; an offset well pressure normalization rate; an offset well cumulative oil production, and an offset well material balance time based on the offset well historical oil production rate data, the offset well bottom hole pressure data, and the offset well initial reservoir pressure data; generating a pressure normalization rate-material balance time curve of offset well historical oil production rate; generating a pressure normalization rate trend for the pseudo boundary flow stage using the offset well historical oil production rate data; estimating a real transition time between the pressure normalization rate trend for the pseudo boundary flow stage and the pressure normalization rate trend for the linear flow stage; and determining at least one of: estimated ultimate recovery and a forecast of oil production based on the offset well historical oil production rate data.

Another embodiment according to the present disclosure may include a system for forecasting oil recovery from a multiply-fractured horizontal oil well, the system comprising: a processor; data storage; and instructions stored in the data storage that, when executed by the processor, cause the processor to: calculating a pressure drop; a pressure normalization rate; a cumulative oil production, and a material balance time for the well using historical oil production rate data, bottom hole pressure data, and an initial reservoir pressure for the first well; generating a pressure normalization rate-material balance time curve of the historical oil production rate data; determining if pseudo boundary flow stage behavior has started for the first well based on the pressure normalization rate-material balance time curve of the historical oil production rate data; and where if the pseudo boundary flow stage behavior has started: generating a pressure normalization rate trend for a pseudo boundary flow stage of the first well; and determining at least one of: an estimated ultimate recovery and a forecast of oil production for the first well; and where if the pseudo boundary flow stage behavior has not started: generating a pressure normalization rate trend for a linear flow stage of the first well; obtaining offset well historical oil production rate data, offset well bottom hole pressure data, and offset well initial reservoir pressure data from a second well, offset from the first well; calculating an offset well pressure drop; an offset well pressure normalization rate; an offset well cumulative oil production, and an offset well material balance time based on the offset well historical oil production rate data, the offset well bottom hole pressure data, and the offset well initial reservoir pressure data; generating a pressure normalization rate-material balance time curve of offset well historical oil production rate; generating a pressure normalization rate trend for the pseudo boundary flow stage using the offset well historical oil production rate data; estimating a real transition time between the pressure normalization rate trend for the pseudo boundary flow stage and the pressure normalization rate trend for the linear flow stage; and determining at least one of: estimated ultimate recovery and a forecast of oil production based on the offset well historical oil production rate data.

Another embodiment according to the present disclosure includes a non-transitory computer-readable medium storing instructions that, when executed by a processor, cause the processor to perform operations, the operations comprising: calculating a pressure drop; a pressure normalization rate; a cumulative oil production, and a material balance time for the well using historical oil production rate data, bottom hole pressure data, and an initial reservoir pressure for the first well; generating a pressure normalization rate-material balance time curve of the historical oil production rate data; determining if pseudo boundary flow stage behavior has started for the first well based on the pressure normalization rate-material balance time curve of the historical oil production rate data; where if the pseudo boundary flow stage behavior has started: generating a pressure normalization rate trend for a pseudo boundary flow stage of the first well; and determining at least one of: an estimated ultimate recovery and a forecast of oil production for the first well; and where if the pseudo boundary flow stage behavior has not started: generating a pressure normalization rate trend for a linear flow stage of the first well; obtaining offset well historical oil production rate data, offset well bottom hole pressure data, and offset well initial reservoir pressure data from a second well, offset from the first well; calculating an offset well pressure drop; an offset well pressure normalization rate; an offset well cumulative oil production, and an offset well material balance time based on the offset well historical oil production rate data, the offset well bottom hole pressure data, and the offset well initial reservoir pressure data; generating a pressure normalization rate-material balance time curve of offset well historical oil production rate; generating a pressure normalization rate trend for the pseudo boundary flow stage using the offset well historical oil production rate data; estimating a real transition time between the pressure normalization rate trend for the pseudo boundary flow stage and the pressure normalization rate trend for the linear flow stage; and determining at least one of: estimated ultimate recovery and a forecast of oil production based on the offset well historical oil production rate data.

Another embodiment according to the present disclosure includes a method for forecasting oil recovery from a multiply-fractured horizontal oil well, the method comprising: calculating a material balance time for the well using historical oil production rate data for the well; generating an oil production rate-material balance time curve of the historical oil production rate data; determining if pseudo boundary flow stage behavior has started for the first well based on the oil production rate-material balance time curve of historical oil production rate data; and where if the pseudo boundary flow stage behavior has started: generating an oil production rate trend for a pseudo boundary flow stage of the first well; and determining at least one of: an estimated ultimate recovery and a forecast of oil production for the first well; and where if the pseudo boundary flow stage behavior has not started: generating an oil production rate trend for a linear flow stage of the first well; obtaining offset well historical oil production rate data from a second well, offset from the first well; calculating an offset well material balance time using the offset well historical oil production rate data; generating an oil production rate-material balance time curve of offset well historical oil production rate; generating an oil production rate trend for the pseudo boundary flow stage using the offset well historical oil production rate data; estimating a real transition time between the oil production rate trend for the pseudo boundary flow stage and the oil production rate trend for the linear flow stage; and determining at least one of: estimated ultimate recovery and a forecast of oil production for the first well.

Another embodiment according to the present disclosure includes system for forecasting oil recovery from a multiply-fractured horizontal oil well, the system comprising: a processor; data storage; and instructions stored in the data storage that, when executed by the processor, cause the processor to: calculating a material balance time for the well using historical oil production rate data for the well; generating an oil production rate-material balance time curve of the historical oil production rate data; determining if pseudo boundary flow stage behavior has started for the first well based on the oil production rate-material balance time curve of historical oil production rate data; and where if the pseudo boundary flow stage behavior has started: generating an oil production rate trend for a pseudo boundary flow stage of the first well; and determining at least one of: an estimated ultimate recovery and a forecast of oil production for the first well; and where if the pseudo boundary flow stage behavior has not started: generating an oil production rate trend for a linear flow stage of the first well; obtaining offset well historical oil production rate data from a second well, offset from the first well; calculating an offset well material balance time using the offset well historical oil production rate data; generating an oil production rate-material balance time curve of offset well historical oil production rate; generating an oil production rate trend for the pseudo boundary flow stage using the offset well historical oil production rate data; estimating a real transition time between the oil production rate trend for the pseudo boundary flow stage and the oil production rate trend for the linear flow stage; and determining at least one of: estimated ultimate recovery and a forecast of oil production for the first well.

Another embodiment according to the present disclosure includes a non-transitory computer-readable medium storing instructions that, when executed by a processor, cause the processor to perform operations, the operations comprising: calculating a material balance time for the well using historical oil production rate data for the well; generating an oil production rate-material balance time curve of the historical oil production rate data; determining if pseudo boundary flow stage behavior has started for the first well based on the oil production rate-material balance time curve of historical oil production rate data; and where if the pseudo boundary flow stage behavior has started: generating an oil production rate trend for a pseudo boundary flow stage of the first well; and determining at least one of: an estimated ultimate recovery and a forecast of oil production for the first well; and where if the pseudo boundary flow stage behavior has not started: generating an oil production rate trend for a linear flow stage of the first well; obtaining offset well historical oil production rate data from a second well, offset from the first well; calculating an offset well material balance time using the offset well historical oil production rate data; generating an oil production rate-material balance time curve of offset well historical oil production rate; generating an oil production rate trend for the pseudo boundary flow stage using the offset well historical oil production rate data; estimating a real transition time between the oil production rate trend for the pseudo boundary flow stage and the oil production rate trend for the linear flow stage; and determining at least one of: estimated ultimate recovery and a forecast of oil production for the first well.

### BRIEF DESCRIPTION OF DRAWINGS

For a detailed understanding of the present disclosure, reference should be made to the following detailed description of the embodiments, taken in conjunction with the accompanying drawings, in which like elements have been given like numerals, wherein:

FIG. 1A shows a schematic diagram showing a multiply-fractured horizontal well;

FIG. 1B shows a diagram of linear stage flow of oil from the formation into fractures;

FIG. 1C shows a diagram of pseudo boundary stage flow of oil from the formation into the fractures;

FIG. 2A shows a flow chart of one embodiment of a method to forecast EUR and oil production for a well with historical bottom hole pressure data;

FIG. 2B shows a continuation of the flow chart of FIG. 2A;

FIG. 3A shows a flow chart of another embodiment of a method to forecast EUR and oil production for a well without historical bottom hole pressure data;

FIG. 3B shows a continuation of the flow chart of FIG. 3A;

FIG. 4A shows a graph with a plot of PNR versus tₘ on a log-log scale for a well with bottom hole pressure data and with a pseudo boundary flow stage;

FIG. 4B shows a graph with a plot of Log₁₀PNR versus Log₁₀tₘ in linear scale for a well with bottom hole pressure data and with a pseudo boundary flow stage;

FIG. 5A shows a graph with a plot of dp versus tₘ in log-log scale for a well with bottom hole pressure data and with a pseudo boundary flow stage;

FIG. 5B shows a graph with a plot of Log₁₀dp versus Log₁₀tₘ in linear scale for a well with bottom hole pressure data and with a pseudo boundary flow stage;

FIG. 6 shows a graph with a plot of forecasted oil production rate and cumulative oil production as a function of real time for a well with bottom hole pressure data and pseudo boundary flow stage;

FIG. 7A shows a graph with a plot of PNR versus tₘ in log-log scale for a well with bottom hole pressure data while in the stage of linear flow stage;

FIG. 7B shows a graph with a plot of Log₁₀PNR versus Log₁₀tₘ in linear scale for a well with bottom hole pressure data while in the stage of linear flow stage;

FIG. 8A shows a graph with a plot of dp versus tm in log-log scale for a well with bottom hole pressure data while in the stage of linear flow stage;

FIG. 8B shows a graph with a plot of Log₁₀dp versus Log₁₀tₘ in linear scale for a well with bottom hole pressure data while in the stage of linear flow stage;

FIG. 9 shows a graph with a plot of forecasted oil production rate and cumulative oil production for a well with bottom hole pressure data while in the stage of linear flow stage;

FIG. 10A shows a graph with a plot of qₒ versus tₘ in log-log scale for a well without bottom hole pressure data and in the pseudo boundary flow stage;

FIG. 10B shows a graph with a plot of Log₁₀qₒ, versus Log₁₀tₘ in linear scale for a well without bottom hole pressure data and in the pseudo boundary flow stage;

FIG. 11 shows a graph with a plot of the forecasted oil production rate and cumulative oil production for a well without bottom hole pressure data and in the pseudo boundary flow stage;

FIG. 12A shows a graph with a plot of qₒ versus tₘ in log-log scale for a well without bottom hole pressure data while in the stage of linear flow stage;

FIG. 12B shows a graph with a plot of Log₁₀qₒ, versus Log₁₀tₘ in linear scale for a well without bottom hole pressure data while in the stage of linear flow stage;

FIG. 13 shows a graph with a plot of the forecasted oil production rate and cumulative oil production for a well without bottom hole pressure data while in the stage of linear flow stage; and

FIG. 14 is a schematic of a computer system configured to implement the method of FIG. 2 according to one embodiment of the present disclosure.

### DETAILED DESCRIPTION OF THE DISCLOSURE

Generally, the present disclosure relates to oil field production forecasting. Specifically, the present disclosure is related to forecasting and estimating ultimate recovery for multiply-fractured horizontal shale oil wells.

There are shown in the drawings, and herein will be described in detail, specific embodiments of the present disclosure with the understanding that the present disclosure is to be considered an exemplification of the principles of the present disclosure and is not intended to limit the present disclosure to that illustrated and described herein.

The multiply-fractured shale oil well has its special characteristics of flow behavior and presents its own challenges to forecasting production. Usually flow behavior of a multiply-fractured shale oil well starts from linear flow stage. Occasionally the bilinear flow behavior can be observed before the linear flow stage, but this bilinear flow behavior will not last long time (usually a couple of days to a couple of weeks). The linear flow stage may last for a couple of months to several years depending on the reservoir properties and the spacing of hydraulic fractures. Then flow behavior then evolves into a pseudo boundary flow stage, which may last for a long period of time, on the order of years or decades. For practical considerations, only the production from the two stages—linear flow stage and pseudo boundary flow stage—need to be considered for the life of the well.

One object of the present disclosure is to accurately forecast the EUR and oil production by identifying the flow behavior based on historical oil production data. In one embodiment of the method, the flow stages may be identified, and then curves may be fitted of the trend for the historical PNR during the period of pseudo boundary flow stage and of the trend of pressure drop, dp. The EUR can be quickly obtained by extending the trend of PNR to the economic limit point. The oil production rate and the cumulative oil production may both be estimated based on the fitted curves. Once the trend of pseudo boundary flow behavior begins, future oil production and EUR of the well may be forecasted. If there is offset well data, which already shows the trend of pseudo boundary flow behavior, the offset well data can be combined with the historical data of the well still in the stage of linear flow stage to forecast its EUR and oil production. For wells without bottom hole pressure data, the oil production rate is used instead of PNR to approximately diagnose the flow stages, and then forecast the EUR and oil production.

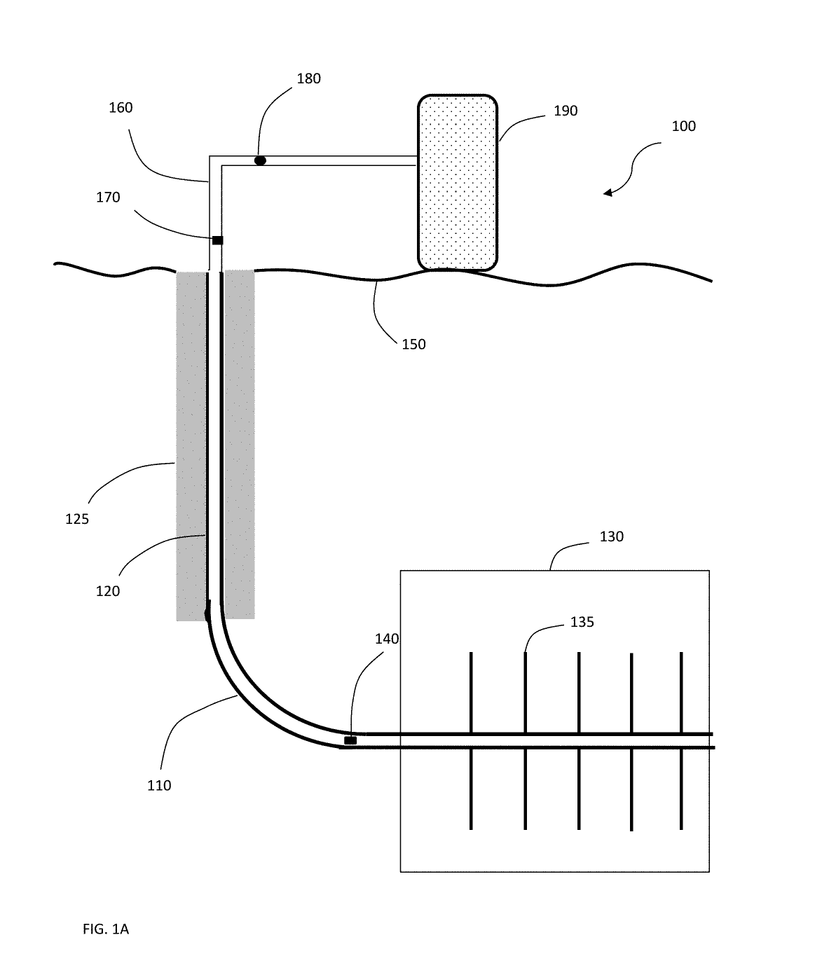

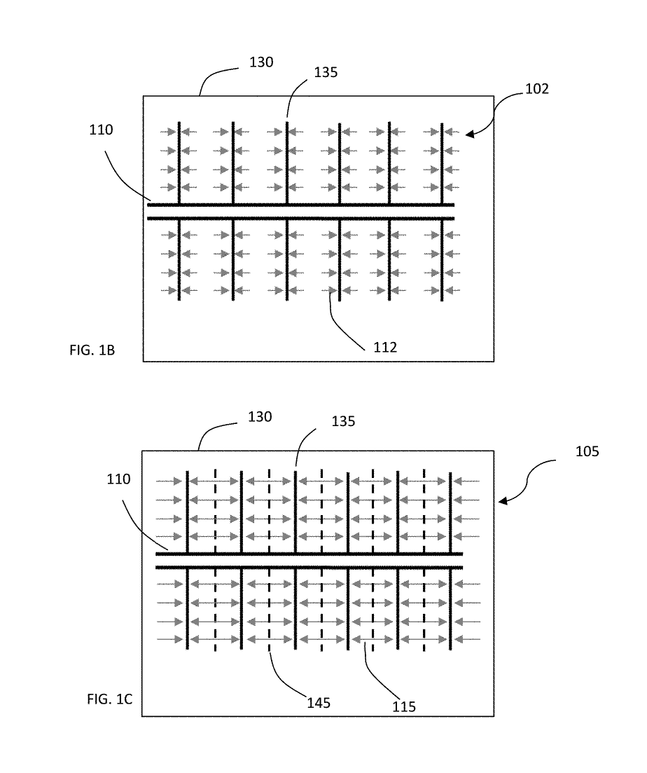

FIG. 1A shows a diagram for a multiply-fractured horizontal well 100. The well may be deviated, or more complex trajectory. The wellbore 110 may be horizontal, deviated, or a more complex trajectory, and the wellbore 110 may have production tubing 120 and casing and cementing 125. The wellbore 110 may penetrate an oil bearing formation 130 and have a plurality of artificial fractures 135, into which oil may flow from the formation 130 into the wellbore 110. One or more pressure sensors 140 may be disposed in the wellbore 110 to measure bottom hole pressure of the well. Above the surface 150, there are pipes 160 to transport the produced oil, water. and gas. A pressure sensor 170 may be disposed in or about the pipes 160 to measure the well head pressure. A fluid velocity meter 180 may also be disposed in or about the pipes 160 to measure the oil production rate. The produced oil may be transported to an oil tank or separator 190.

FIG. 1B shows a diagram of linear stage flow 102 when oil moves from the formation 130 into the fractures 135 as shown by arrows 112. The oil flow 112 is only from the areas of the formation 130 in close proximity to the fractures during the early stage of production. Close proximity means that the oil flow 112 is still far enough from adjacent fractures 135 such that the individual fractures are not competing for oil flow from the formation 125.

FIG. 1C shows a diagram of pseudo boundary flow 105 when the oil moves from the formation 130 into the fractures 135, shown by arrows 115, and the flow of the oil into one fracture 135 competes with adjacent fractures 135 (i.e. reaches its neighbor fractures' oil flow front) which generates a virtual boundary 145 between the fractures 135.

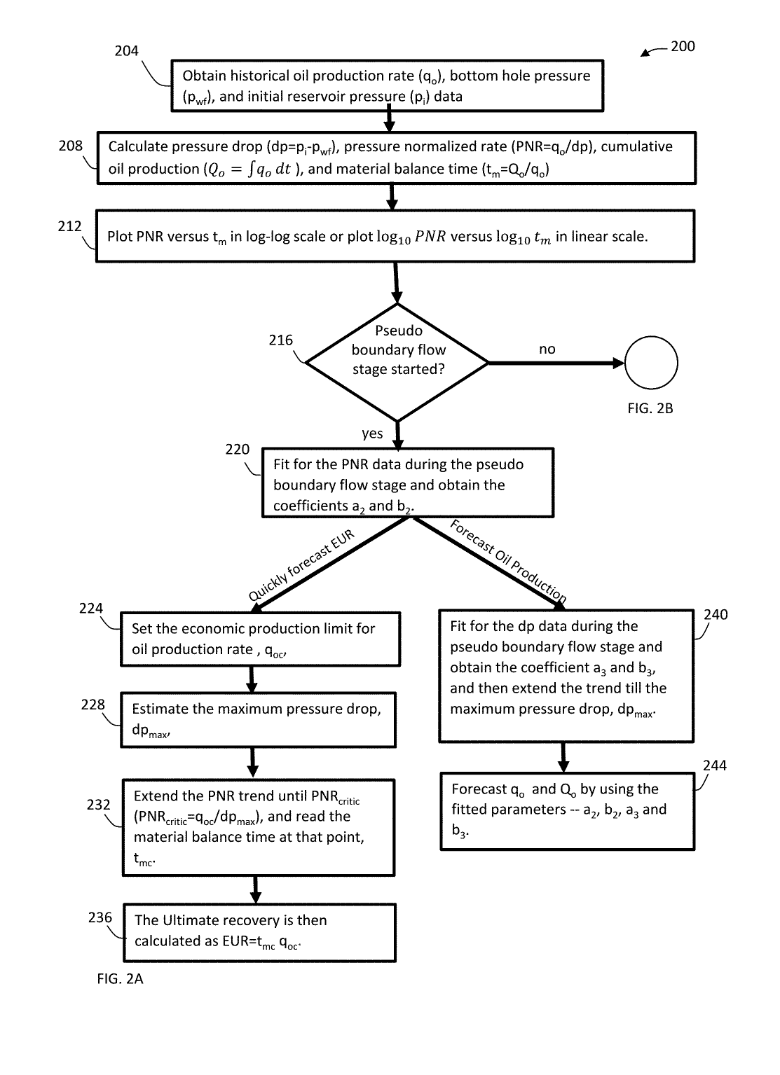

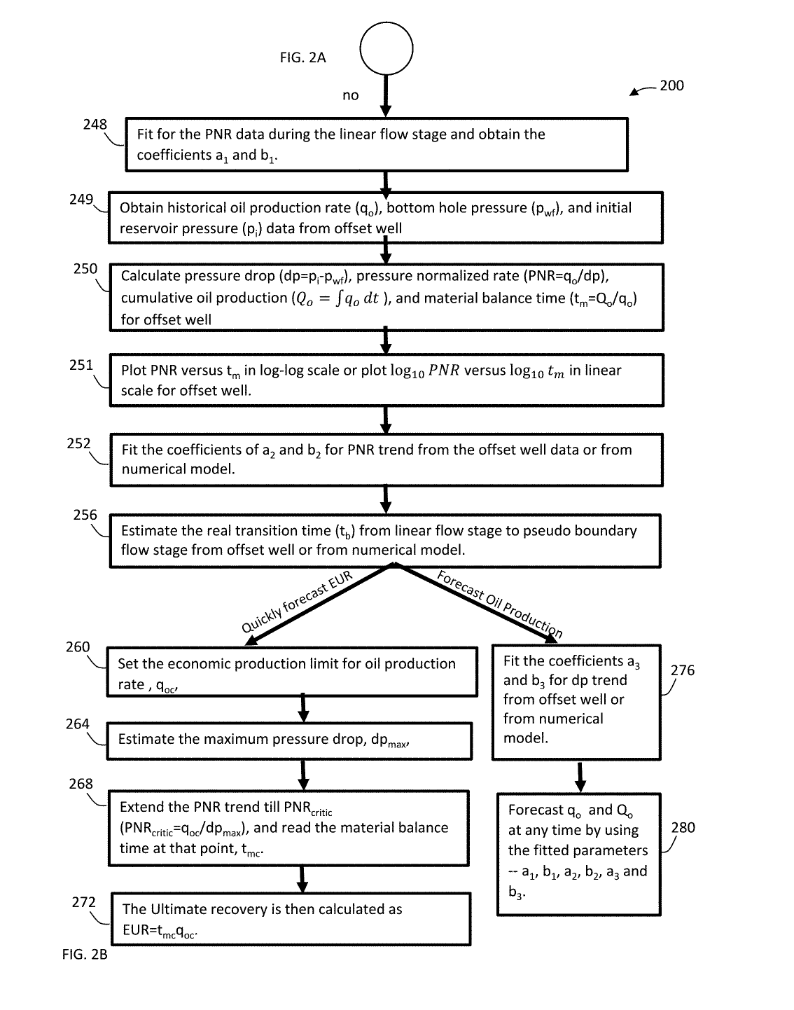

FIG. 2 shows an embodiment of a method 200 of forecasting EUR and oil production for a well with bottom hole pressure data. In step 204, historical oil production rate, qₒ, bottom hole pressure, p_{wf}, and the initial reservoir pressure, pᵢ, data are obtained. qₒ, p_{wf}, and pᵢ may be obtained through direct measurements using the pressure sensor 140, the pressure sensor 170, and the fluid velocity meter 180 and/or historical records of said data for a particular well. In step 208, a pressure drop, dp, may be calculated based on p_{wf} and pᵢ (dp=pᵢ−p_{wf}), the pressure normalized rate, PNR, may be calculated from qₒ and dp (PNR=qₒ/dp), the cumulative oil production, Qₒ, may be calculated based on qₒ by summing qₒ for the history of the well, and the material balance time, tₘ, may be calculated from Qₒ and qₒ (tₘ=Qₒ/qₒ). In step 212, the PNR data are plotted versus the material balance time, tₘ, for the history of the well to generate a PNR-material balance time curve. In step 216, the method branches based on whether the pseudo boundary flow behavior has already started. The pseudo boundary flow behavior is observed as the slope of the trend (a₂) is stabilizing at a value close to −1 (usually in a range of about −0.85 to −1.00). In some embodiments, the slope of the trend for pseudo boundary flow behavior may be in a range of −0.90 to −1.00.

If the pseudo boundary flow behavior has begun, then, in step 220, the PNR data during the period of pseudo boundary flow stage may be curve fitted by using a trend function (i.e. log₁₀ qₒ/dp=a₂ log₁₀ tₘ+b₂) wherein a₂ and b₂ may be determined. The PNR trend generated for the pseudo boundary flow stage will have a slope, a₂, that is consistent with pseudo boundary flow behavior. After step 220, the EUR and/or the oil production may be forecast. To forecast EUR, in step 224, the critical production rate, q_{oc}, may be set for the oil production rate, qₒ. The critical production rate may be determined based on economic factors, such as, but not limited to, the cost of production and price of oil, as would be understood by a person of ordinary skill in the art. In step 228, the maximum pressure drop, dpₘₐₓ may be estimated. In some embodiments, steps 224 and 228 may be performed simultaneously or in reverse order. In step 232, the PNR trend for the pseudo boundary flow stage may be extended until the critical production rate is reached, which is also the economic limit for the well. The economic limit is reached when the PNR line reaches its critical value, PNR_{critic}, which is a function of q_{oc} and which is the point where production is no long economically feasible. The intersection of the PNR trend with PNR_{critic} provides the critical material balance time, t_{mc}, for the well. In step 236, the EUR may be determined based on the values of q_{oc} and t_{mc}. In some embodiments, EUR=q_{oc} t_{mc}.

To forecast the oil production rate and cumulative oil production, in step 240, the dp data during the pseudo boundary flow stage may be curve fit to generate a dp trend using a function, log₁₀ dp=a₃ log₁₀ tₘ+b₃, where a₃ and b₃ are coefficients. The dp trend may then be extended to the point of maximum pressure drop dpₘₐₓ. In step 244, the values of qₒ and Qₒ may be forecast using the coefficients a₂, b₂, a₃, and b₃.

If, in step 216, the pseudo boundary flow behavior has not started, then, in step 248, the PNR data during the period of linear flow may be curve fitted using a trend function, such as log₁₀ qₒ/dp=a₁ log₁₀ tₘ+b₁, where a₁ and b₁ may be determined. In step 249, offset well data may be obtained for one or more of the historical oil production rate, qₒ, the bottom hole pressure, p_{wf}, and the initial reservoir pressure, pᵢ. An offset well is a producing well with similar production behavior as the well with behavior being forecast. Typically, the offset well will be a well producing in the same reservoir and proximal in distance, as would be understood by a person of ordinary skill in the art, to the well for which the forecast is being performed. In step 250, the pressure drop, pressure normalized rate, cumulative oil production, and material balance time may be calculated in the same or a similar manner as performed in step 208. In step 251, the PNR-material balance time curve is generated for the history of the well in the same or a similar manner as in step 212. In step 252, the coefficients a₂ and b₂ may be fitted to generate a PNR trend for the pseudo boundary flow stage from the offset well data or from a numerical reservoir simulation model. In step 256, the transition time from the linear flow stage to the pseudo boundary flow stage, t_{b}, may be estimated from the offset well data or from numerical reservoir simulation, as well as the trends of PNR and dp in the pseudo boundary flow stage. After step 256, the EUR and/or the oil production may be forecast. To forecast the EUR, in step 260, the critical production rate may be set for the oil production rate, qₒ, similar to step 224. In step 264, the maximum pressure drop, dpₘₐₓ may be estimated similar to step 228. In some embodiments, steps 260 and 264 may be performed simultaneously or in reverse order. In step 268, the trend of PNR may be extended until the critical production rate (i.e. economic limit) is reached. The economic limit is reached when the PNR line reaches its critical value, PNR_{critic}, which is the point where production is no long economically feasible. In step 272, the EUR may be determined based on the vales of q_{oc} and t_{mc}. In some embodiments, EUR=q_{oc} t_{mc}.

The oil production rate and cumulative oil production may be calculated using the fitted parameters from offset wells. To forecast oil production, in step 276, the dp data from the offset well data or a numerical reservoir simulation during the pseudo boundary flow stage may be curve fit using a function, log₁₀ dp=a₃ log₁₀ tₘ+b₃, where a₃ and b₃ are coefficients. The trend of the data may then be extended to the point of maximum pressure drop dpₘₐₓ. In step 280, the values of qₒ and Qₒ may be forecast using the coefficients a₁, b₁, a₂, b₂, a₃, and b₃.

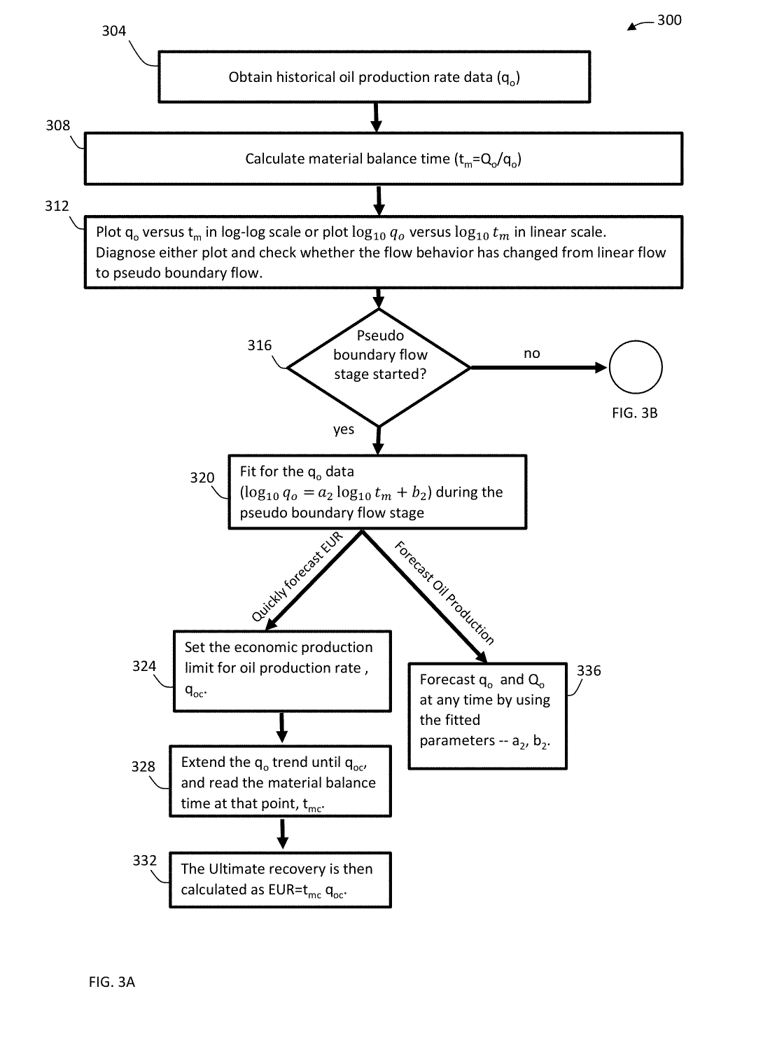

FIG. 3 shows another embodiment of a method 300 of forecasting EUR and oil production for a well with bottom hole pressure data. In step 304, historical oil production rate, qₒ, data are obtained. In step 308, the material balance time, tₘ, may be calculated from Qₒ and go (tₘ=Qₒ/q₀). The cumulative oil production, Qₒ, may be calculated from qₒ by summing qₒ for the history of the well. In step 312, the historical oil production rate, qₒ, may be plotted versus tₘ. In step 316, the plot of historical oil production rate versus tₘ may be analyzed to determine if pseudo boundary flow behavior has started. In step 320, if the pseudo boundary flow behavior has begun, the oil production rate during the period of pseudo boundary flow stage may be curve fitted by using a trend function (i.e. log₁₀ qₒ=a₂ log₁₀ tₘ+b₂) wherein a₂ and b₂ may be determined. The production rate trend (qₒ trend) generated for the pseudo boundary flow stage will have a slope, a₂, that is consistent with pseudo boundary flow behavior. After step 320, the EUR and/or the oil production may be forecast. To forecast EUR, in step 324, the critical production rate may be set for the oil production rate, q_{oc}. The critical production rate may be determined based on economic factors, such as, but not limited to, the cost of production and price of oil, as would be understood by a person of ordinary skill in the art. In step 328, the trend of qₒ may be extended to the critical production rate, where the qₒ trend intersects q_{oc}, to determine the critical value of mass flow t_{mc}. In step 332, the EUR may be determined based on the values of q_{oc} and t_{mc}. In some embodiments, EUR=q_{oc} t_{mc}. To forecast the oil production rate and/or the cumulative oil production, in step 336, the values of qₒ and Qₒ may be determined from the coefficients a₂ and b₂. If, in step 316, the well is still at the stage of linear flow, then, in step 340, the qₒ data during the period of linear flow may be curve fitted using a trend function, such as log₁₀ qₒ=a₁ log₁₀ tₘ+b₁, where a₁ and b₁ may be determined. In step 341, offset well data may be obtained for one or more of the historical oil production rate, qₒ, the bottom hole pressure, p_{wf}, and the initial reservoir pressure, pᵢ. An offset well is a producing well with similar production behavior as the well with behavior being forecast. Typically, the offset well will be a well producing in the same reservoir and proximal in distance, as would be understood by a person of ordinary skill in the art, to the well for which the forecast is being performed. In step 342, the pressure drop, pressure normalized rate, cumulative oil production, and material balance time may be calculated in the same or a similar manner as performed in step 308. In step 343, the oil production rate data are plotted versus the material time balance for the history of the well in the same or a similar manner as in step 312. In step 344, the coefficients a₂ and b₂ may be fitted for the qₒ trend from the offset well data or from a numerical reservoir simulation model. In step 348, the transition time from the linear flow stage to the pseudo boundary flow stage may be estimated using the offset well data or from numerical reservoir simulation, as well as the trend of qₒ in the pseudo boundary flow stage. After step 348, the EUR and/or the oil production may be forecast. To forecast the EUR, in step 352, the critical production rate may be set for the oil production rate, q_{oc} similar to step 324. In step 356, the qₒ trend may be extended for the pseudo boundary flow stage until the qₒ trend intersects q_{oc}. In step 360, the EUR may be determined based on the values of q_{oc} and t_{mc}. In some embodiments, EUR=q_{oc} t_{mc}. To forecast the oil production rate and/or cumulative production, in step 364, the values of qₒ and Qₒ may be estimated using the coefficients a₁, b₁, a₂, and b₂.

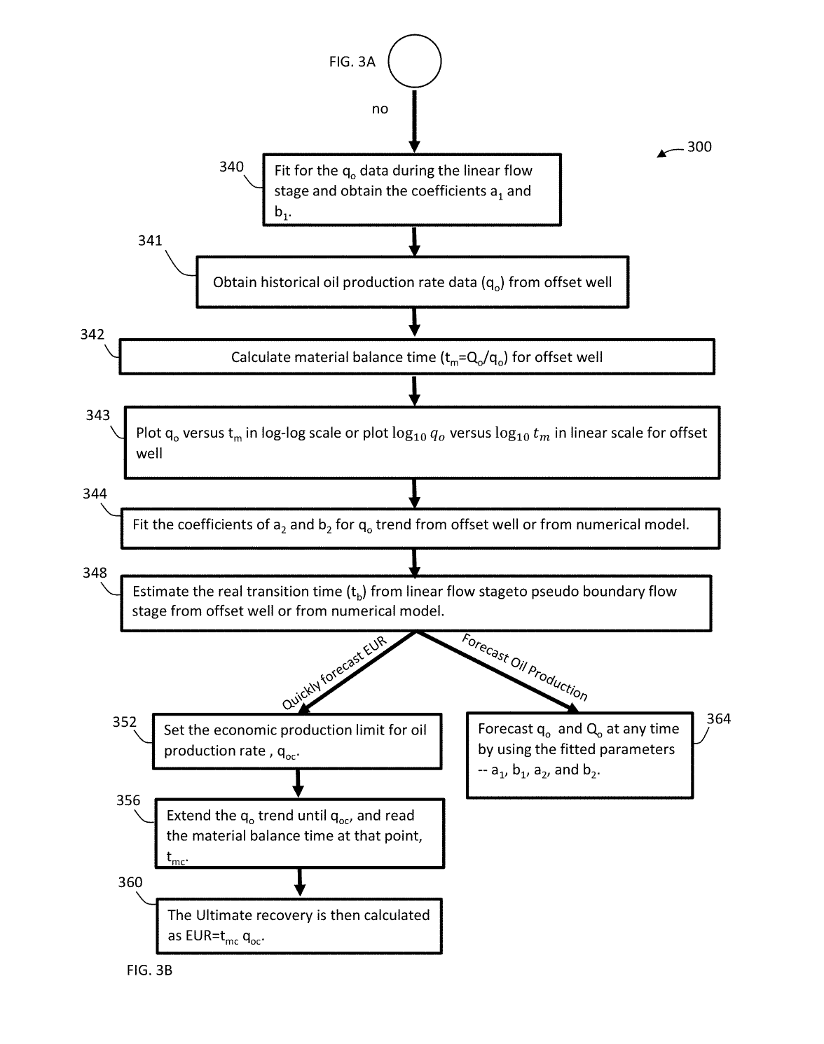

FIG. 4A shows a graph with a plot 400 of historical oil production data points 410 in terms of PNR versus tₘ in log-log scale. The data shows two distinguishable slopes. A first slope is indicated by line 420, which has a slope of −0.5 and indicates the linear flow stage. A second slope is indicted by line 430, which has a slope of about −1.0 and indicates the pseudo boundary flow stage. As discussed above, a trend in the pseudo boundary flow stage can have a slope of about −0.85 to −1.00. The data during the linear flow stage are curve fitted by using the function, log₁₀ qₒ/dp=a₁ log₁₀ tₘ+b₁, and the parameters a₁ and b₁ are obtained from the fitting. The data during the pseudo boundary flow stage are curve fitted by using the function, log₁₀ qₒ/dp=a₂ log₁₀ tₘ+b₂, and the parameters a₂ and b₂ are obtained from the fitting. For the example used in the plot 400, the fitted parameters are a₁=−0.5, b₁=0.3, a₂=−0.995 and b₂=1.2. The maximum pressure drop, dpₘₐₓ, for the well is 2750 psi, and the minimum economic oil production rate, q_{oc}, is assumed as 1 stb/day. The above parameters are exemplary and illustrative only. And the critical economic PNR, PNR_{critic}, will be 0.000364 stb/day/psi (PNR_{critic}=q_{oc}/dpₘₐₓ=1stb/day/2750 psi). The line 430 is the PNR trend and may be extended to PNR_{critic} 440, and the intersection point 450 is used to read the material balance time at the economic limit point, t_{mc}. The corresponded material balance time for the intersection point is the t_{mc} 460, which is read from the plot as 46,000 days. According to the definition of the material balance time (tₘ=Qₒ/qₒ), the EUR will be 46,000 stb (Qₒ=t_{mc}×qₒ 46,000 day×1 stb/day=46,000 stb) for the well.

FIG. 4B shows a graph with a plot 405, which represents the data 410 in logarithmic form, or Log₁₀PNR versus Log₁₀tₘ in linear scale, to produce line 425 representing the linear flow stage and line 435 representing the pseudo boundary flow stage. By using the same processes as described for FIG. 4A, the line 435 may be extended to Log₁₀PNR_{critic}(Log₁₀0.000364=−3.439) 445, and the intersection of lines 435 and 445 is the economic limit point 455. The corresponding Log₁₀tₘ for the economic limit point is Log₁₀t_{mc} 465, which is read from the plot as 4.663. The material balance time is 46,000 days (t_{mc}=10⁴⁶⁶³≈46000). Thus, in the present example, the EUR is calculated as 46,000 stb, and the parameters are obtained from the fittings as a₁=−0.5, b₁=0.3, a₂=−0.995 and b₂=1.2.

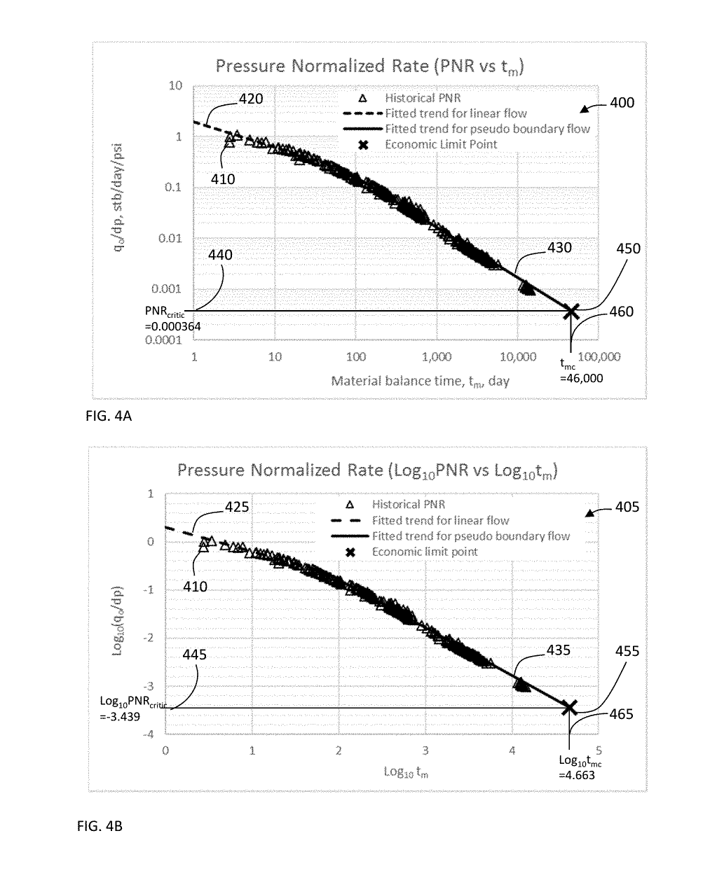

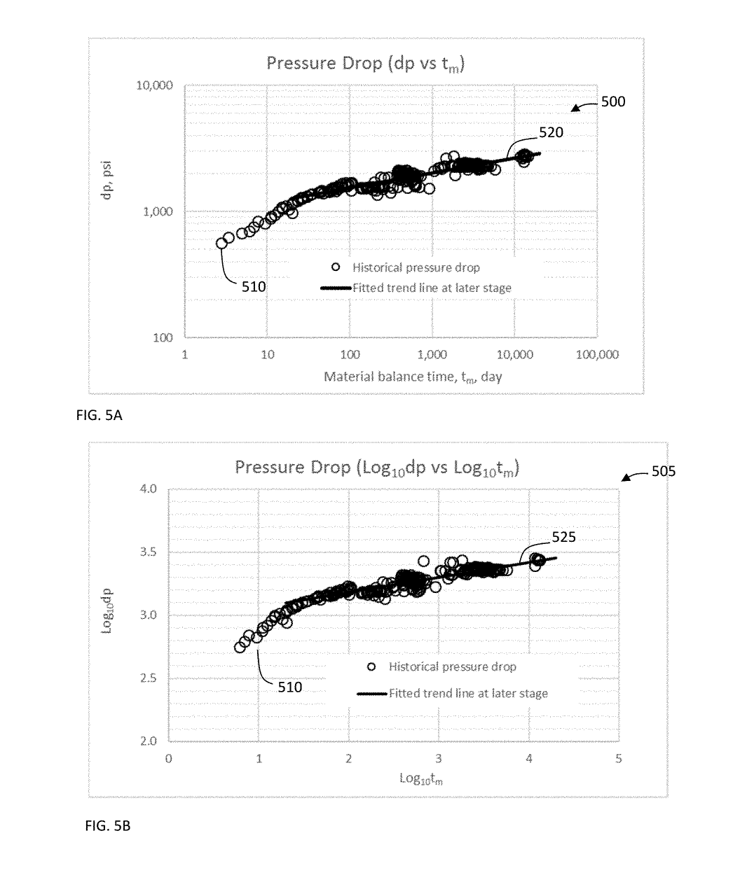

FIG. 5A shows a graph with the plot of dp versus tₘ in log-log scale. The exemplary dp data in pseudo boundary flow stage is fitted by using the function, log₁₀ dp=a₃ log₁₀ tₘ+b₃, and the parameters a₃ and b₃ are obtained from the fitting as: a₃=−0.1184 and b₃=2.9471. The dp will follow the fitted trend before it reaches the maximum pressure drop, dpₘₐₓ, and then it will become constant as dpₘₐₓ. The PNR will continually follow the trend during the stage of pseudo boundary flow even after dp reaches dpₘₐₓ. The time of dp reaches the dpₘₐₓ is calculated from the analytical solution,

t_{dpmax}=t₀(a₂+a₃+1)10(log₁₀dpₘₐₓ−b₃)/a₃−X₀^{1/(a}^{₂}^{+a}^{₃}⁺¹⁾ (1)

Where tₒ is the total historical oil production time, and

X₀=Qₒ₀(a₂+a₃+1)^{(a}^{₂}^{+a}^{₃}⁺¹⁾10^{-(b}^{₂}^{+b}^{₃}⁾ (2)

Where Q_{O0} is the cumulative oil production at the last historical point.

FIG. 5B shows a graph with the plot Log₁₀dₚ versus Log₁₀tₘ in linear scale. As in FIG. 5A, the parameters a₃ and b₃ may be obtained from the fitting as: a₃=−0.1184 and b₃=2.9471.

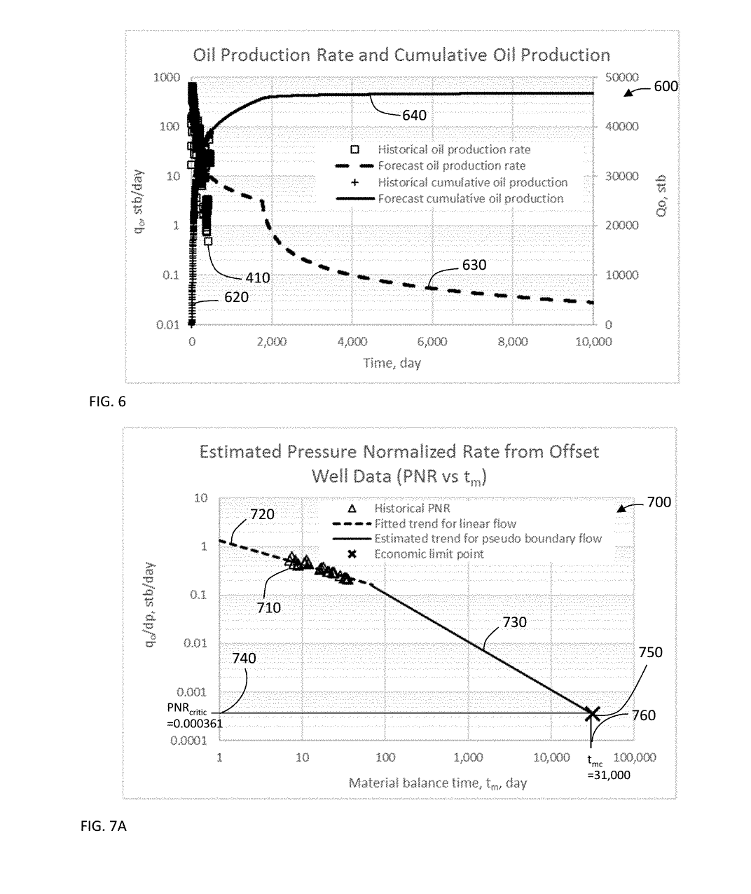

FIG. 6 shows a graph of the forecasted qₒ and Qₒ. The historical oil production rate data 410 and the cumulative oil production data 620 may be show on a plot 600. The forecast production rate 630 and the forecast cumulative oil production 640 may be estimated based on their respective historical data points.

The tₒ and Q_{O0} in the example shown in FIG. 6 are 495 days and 39,045 stb, respectively. Combining with the fitted parameters for a₂, b₂, a₃, and b₃, the t_{dpmax} is calculated as 1,757 days.

When t≤t_{dpmax}, the cumulative oil production and oil production rate can be calculated by the analytical solutions:

$$\begin{matrix}{Q}_{o} = {( {a}_{2} + {a}_{3} + 1 )}^{- ( {a}_{2} + {a}_{3} + 1 )} {10}^{( {b}_{2} + {b}_{3} )} {{X}_{0} [ 1 + ( t - {t}_{0} ) {X}_{0}^{- 1 / ( {a}_{2} + {a}_{3} + 1 )} ]}^{( {a}_{2} + {a}_{3} + 1 )} & ( 3 ) \\ {q}_{o} = {( {a}_{2} + {a}_{3} + 1 )}^{- ( {a}_{2} + {a}_{3} )} {10}^{( {b}_{2} + {b}_{3} )} {{X}_{0}^{( {a}_{2} + {a}_{3} ) / ( {a}_{2} + {a}_{3} + 1 )} [ 1 + ( t - {t}_{0} ) {X}_{0}^{- 1 / ( {a}_{2} + {a}_{3} + 1 )} ]}^{( {a}_{2} + {a}_{3} )} & ( 4 )\end{matrix}$$

When t>t_{dpmax}, the cumulative oil production and oil production rate can be calculated by the analytical solutions:

$$\begin{matrix}{Q}_{o} = {( {a}_{2} + 1 )}^{- ( {a}_{2} + 1 )} {10}^{{b}_{2}} {dp}_{max} {{Z}_{0} [ 1 + ( t - {t}_{dpmax} ) {Z}_{0}^{- 1 / ( {a}_{2} + 1 )} ]}^{( {a}_{2} + 1 )} & ( 5 ) \\ {q}_{o} = {( {a}_{2} + 1 )}^{- {a}_{2}} {10}^{{b}_{2}} {dp}_{max} {{Z}_{0}^{{a}_{2} / ( {a}_{2} + 1 )} [ 1 + ( t - {t}_{dpmax} ) {Z}_{0}^{- 1 / ( {a}_{2} + 1 )} ]}^{{a}_{2}} \\ Where & ( 6 ) \\ {Z}_{o} = {( {a}_{2} + 1 )}^{( {a}_{2} + 1 )} {10}^{{b}_{3}} {( {dp}_{max} )}^{- 1} {10}^{( {log}_{10} {dp}_{max} - {b}_{3} ) ( {a}_{2} + {a}_{3} + 1 ) / {a}_{3}} & ( 7 )\end{matrix}$$

For wells with the production that is still in the linear flow stage, the transition time from the linear flow stage to the pseudo boundary flow stage may need to be estimated from the offset well data which have already shown the pseudo boundary flow behavior or from numerical reservoir simulation. And then the future trends of PNR and dp are estimated and adjusted from the fitted trends of the current well and also offset well.

FIG. 7A shows a graph with a plot 700 of PNR versus tₘ in log-log scale for a well with short time production data 710, which is an offset well of the example well used in the Figures—FIGS. 4A, 4B, 5A, 5B, and 6. The transition time (material balance time), t_{mb}, from the linear flow stage to the pseudo boundary flow stage is found on the plot at the time of intersection between the linear flow trend line and the pseudo boundary flow trend line in FIG. 4A or FIG. 4B. The t_{mb} can be calculated from the fitted parameters (Log₁₀t_{mb}=(b₂−b₁)/(a₁−a₂)) from FIG. 4A or FIG. 4B or directly read from FIG. 4A or FIG. 4B, and the t_{mb} is 66 days. The historical data 710 may then be fitted by using the function, log₁₀ qₒ/dp=a₁ log₁₀ tₘ+b₁, and the fitted parameters a₁ and b₁ are −0.5 and 0.13, respectively, to form a historical PNR trend 720. To keep the same transition time, t_{mb}=66 days, b₂ is adjusted to be 1.0307. But a₂ is kept as −0.995. The PNR trend 730 is forecast from a₂ and b₂. The dpₘₐₓ is 2767 psi, and the qₒ is assumed as 1 stb/day. The PNR_{critic} will be 0.000361 stb/day/psi (PNR_{critic}=q_{oc}/dpₘₐₓ=1stb/day/2767 psi). After extending the forecast PNR trend 730 to an intersection 750 with a line 740 representing PNR_{critic}, the t_{mc} line 760 is read from the plot as 31,000 days. According to the definition of the material balance time (tₘ=Qₒ/qₒ), the EUR will be 31,000 stb (Qₒ=t_{mc}×q_{oc}=31,000 days×1 stb/day=31,000 stb) for the well.

FIG. 7B shows the plot of Log₁₀PNR versus Log₁₀tₘ in linear scale for the well with short term production data 710. Herein the line 725 represents a log value of the line 720, and the log value of PNRcritic is shown as line 745, which forms an intersection 755 with the log value of the pseudo boundary stage flow trend line 735. From this intersection 755, the log value of the critical mass flow line 765 can be determined

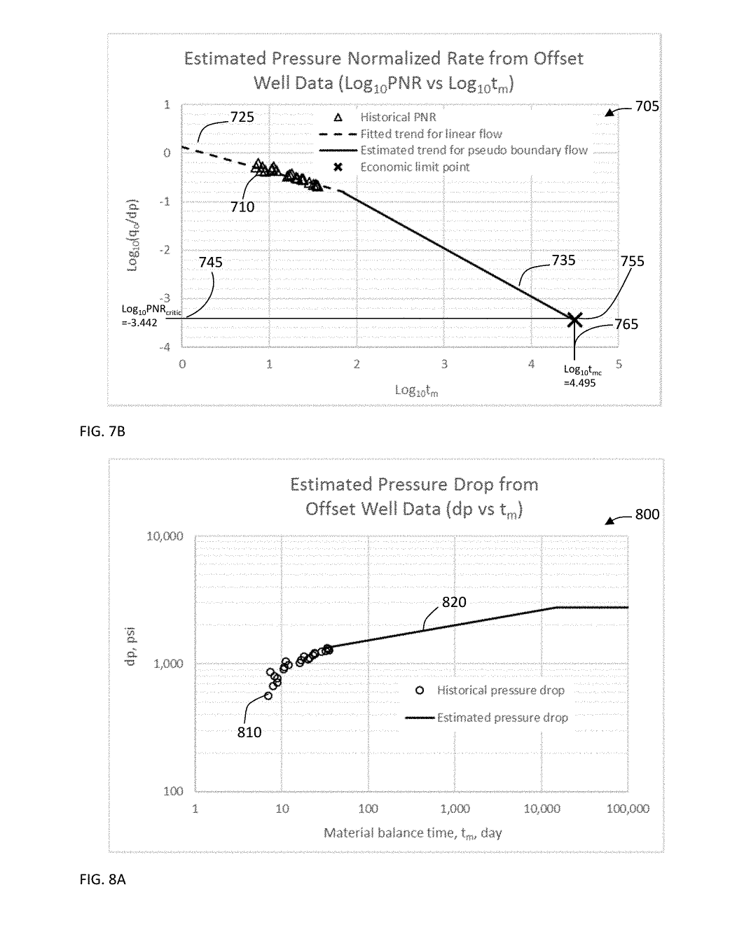

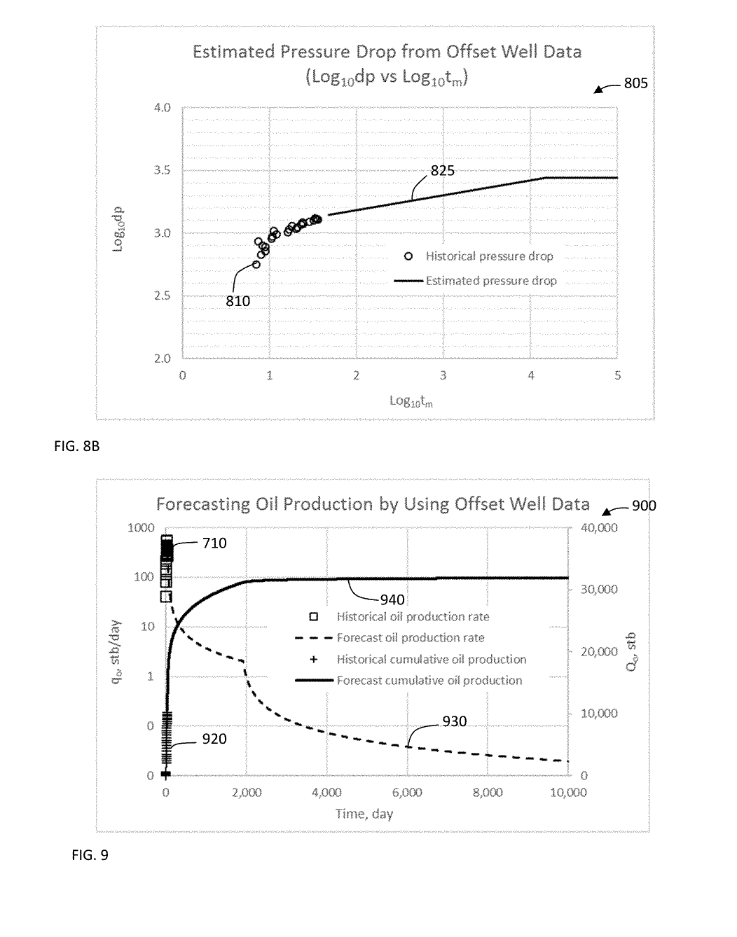

FIG. 8A shows a graph with the plot 800 of dp versus tₘ in log-log scale for the well with short term production. The future trend of pressure drop 820 is estimated from the offset well data, and the fitted parameters a₃ and b₃ from the offset well are kept because the trend line matches with the historical dp data 810, otherwise the parameters a₃ and b₃ need to be adjusted. The maximum pressure drop, dpₘₐₓ of the well is 2767 psi. The dp will follow the trend of dp until it reaches dpₘₐₓ, and then keep as constant tpₘₐₓ.

FIG. 8B shows a graph with a plot 805 plot Log₁₀dp versus Log₁₀tₘ in linear scale. The log-log trend 825 is estimated from the offset well data, which also matches with the historic data 810. The future trend of dp is estimated as described for FIG. 8A.

FIG. 9 shows a graph of a plot 900 of the forecasted qₒ and Qₒ for the well with short term production by using the offset well data. The historical oil production rate data 710 and the historical cumulative production data 920 may be extrapolated to forecast future oil production rate 930 and future cumulative production 940. The transition time (real time), t_{b}, from the linear flow stage to the pseudo boundary flow stage is calculated by the analytical solution:

t_{b}=t₀+t_{mb}(a₁+a₃+1)−X₀^{1/(a}^{₁}^{+a}^{₃}⁺¹⁾ (8)

Where

X₀=Qₒ₀(a₁+a₃+1)^{(a}^{₁}^{+a}^{₃}⁺¹⁾10^{-(b}^{₁}^{+b}^{₃}⁾ (9)

The tₒ and Qₒ₀ in the example shown in FIG. 9 are 32 days and 10,176 stb, respectively, and the t_{mb} is 66 days. Combining with the fitted parameters for a₁, b₁, a₃, and b₃, the t_{b} is calculated as 53 days.

The time, t_{dpmax}, of the pressure drop reaches the maximum pressure drop is calculated by the analytical solution:

t_{dpmax}=t_{b}(a₂+a₃+1)10^{(log}^{₁₀}^{dp}^{ₘₐₓ}^{-b}^{₃}^{)/a}^{₃}−X_{b}^{1/(a}^{₂}^{+a}^{₃}⁺¹⁾ (9a)

Where

X_{b}=Q_{ob}(a₂+a₃+1)^{(a}^{₂}^{+a}^{₃}⁺¹⁾10^{-(b}^{₂}^{+b}^{₃}⁾ (9b)

Where Q_{ob} is the cumulative production at the time t_{b} and can be calculated by the analytical solution:

$${Q}_{ob} = {( {a}_{1} + {a}_{3} + 1 )}^{- ( {a}_{1} + {a}_{3} + 1 )} {10}^{( {b}_{1} + {b}_{3} )} {{X}_{0} [ 1 + ( {t}_{b} - {t}_{0} ) {X}_{0}^{- 1 / ( {a}_{1} + {a}_{3} + 1 )} ]}^{( {a}_{1} + {a}_{3} + 1 )} \qquad ( 10 )$$

The Q_{ob} and t_{dpmax} are 15,931 stb and 1,916 days, respectively.
For t≤t_{b}, the cumulative oil production and oil production rate are calculated by the following analytical solutions:

$$\begin{matrix}{Q}_{o} = {( {a}_{1} + {a}_{3} + 1 )}^{- ( {a}_{1} + {a}_{3} + 1 )} {10}^{( {b}_{1} + {b}_{3} )} {{X}_{0} [ 1 + ( t - {t}_{0} ) {X}_{0}^{- 1 / ( {a}_{1} + {a}_{3} + 1 )} ]}^{( {a}_{1} + {a}_{3} + 1 )} & ( 11 ) \\ {q}_{o} = {( {a}_{1} + {a}_{3} + 1 )}^{- ( {a}_{1} + {a}_{3} )} {10}^{( {b}_{1} + {b}_{3} )} {{X}_{0}^{( {a}_{1} + {a}_{3} ) / ( {a}_{1} + {a}_{3} + 1 )} [ 1 + ( t - {t}_{0} ) {X}_{0}^{- 1 / ( {a}_{1} + {a}_{3} + 1 )} ]}^{( {a}_{1} + {a}_{3} )} & ( 12 )\end{matrix}$$

For t_{b}<t≤t_{dpmax}, the cumulative oil production and oil production rate may be calculated by the following analytical solutions:

$$\begin{matrix}{Q}_{o} = {( {a}_{2} + {a}_{3} + 1 )}^{- ( {a}_{2} + {a}_{3} + 1 )} {10}^{( {b}_{2} + {b}_{3} )} {{X}_{b} [ 1 + ( t - {t}_{b} ) {X}_{b}^{- 1 / ( {a}_{2} + {a}_{3} + 1 )} ]}^{( {a}_{2} + {a}_{3} + 1 )} & ( 13 ) \\ {q}_{o} = {( {a}_{2} + {a}_{3} + 1 )}^{- ( {a}_{2} + {a}_{3} )} {10}^{( {b}_{2} + {b}_{3} )} {{X}_{b}^{( {a}_{2} + {a}_{3} ) / ( {a}_{2} + {a}_{3} + 1 )} [ 1 + ( t - {t}_{b} ) {X}_{b}^{- 1 / ( {a}_{2} + {a}_{3} + 1 )} ]}^{( {a}_{2} + {a}_{3} )} & ( 14 )\end{matrix}$$

For t>t_{dpmax}, the cumulative oil production and oil production rate may be calculated by the following analytical solutions:

$$\begin{matrix}{Q}_{o} = {( {a}_{2} + 1 )}^{- ( {a}_{2} + 1 )} {10}^{{b}_{2}} {dp}_{max} {{Z}_{0} [ 1 + ( t - {t}_{dpmax} ) {Z}_{0}^{- 1 / ( {a}_{2} + 1 )} ]}^{( {a}_{2} + 1 )} & ( 15 ) \\ {q}_{o} = {( {a}_{2} + 1 )}^{- {a}_{2}} {10}^{{b}_{2}} {dp}_{max} {{Z}_{0}^{{a}_{2} / ( {a}_{2} + 1 )} [ 1 + ( t - {t}_{dpmax} ) {Z}_{0}^{- 1 / ( {a}_{2} + 1 )} ]}^{{a}_{2}} & ( 16 )\end{matrix}$$

### Where

Zₒ=(a₂+1)^{(a}^{₂}⁺¹⁾10^{b}^{₃}(dpₘₐₓ)⁻¹10^{(log}^{₁₀}^{dp}^{ₘₐₓ}^{-b}^{₃}^{)(a}^{₂}^{+a}^{₃}^{+1)/a}^{₃} (17)

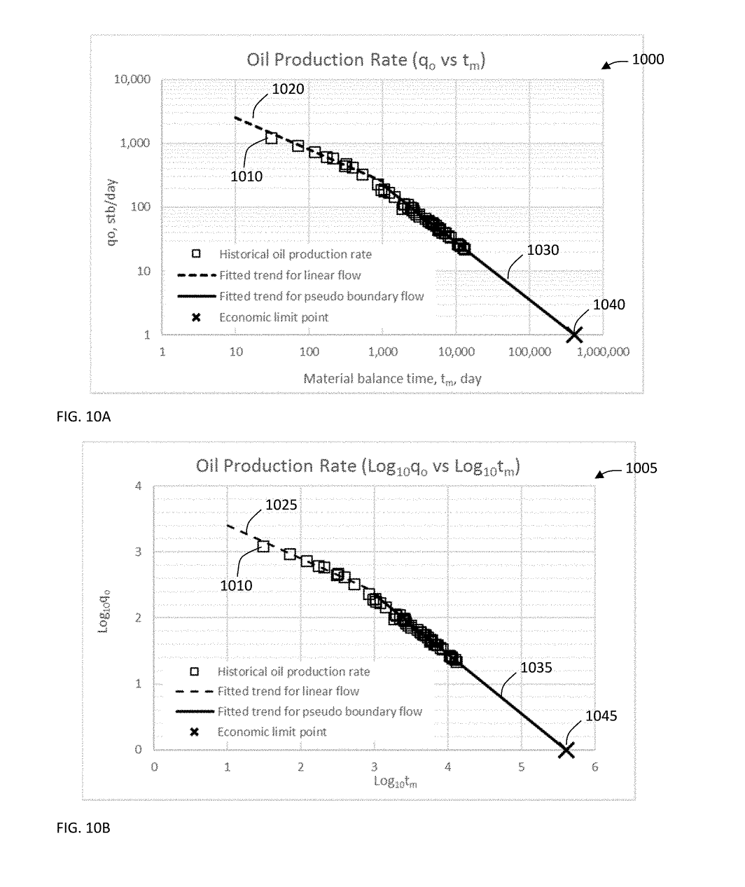

In some cases, bottom hole pressure data may not be available for a well. Usually, for a multiply-fractured horizontal well, the bottom hole pressure drops very fast in the first several months, and then drops slowly thereafter. Therefore, it is possible to identify the flow behavior even without the bottom hole pressure data. FIGS. 10A and 10B show oil production rate for a well without bottom hole pressure data. The two main flow stages can be identified from either plot.

FIG. 10A shows a graph with a plot 1000 of the historical oil production rate data 1010 as qₒ versus tₘ in log-log scale, and the fitted lines for two flow stages—linear flow 1020 and pseudo boundary flow 1030. The data during the linear flow stage is fitted by using the function log₁₀ qₒ=a₁ log₁₀ tₘ+b₁, and the parameters a₁ and b₁ obtained from the fitting are—−0.5 and 3.9, respectively. The data during the pseudo boundary flow stage is fitted by using the function, log₁₀qₒ=a₂ log₁₀ tₘ+b₂, and the fitted parameters a₂ and b₂ are −0.9 and 5.05, respectively. The q_{oc} is assumed as 1 stb/day. After extending the trend of oil production rate until qₒ, at the intersection 1040, the t_{mc} is read from FIG. 10A as 408,000 days. According to the definition of the material balance time (tₘ=Qₒ/qₒ), the EUR will be 408,000 stb (Qₒ=t_{mc}×q_{oc}=408,000 days×1 stb/day=408,000 stb) for the well. FIG. 10B shows the plot Log₁₀qₒ versus Log₁₀tₘ in linear scale. By using the same method, the trend curves can be fitted and EUR can be calculated.

FIG. 10B shows a graph of a plot 1005, which is a log-log plot of FIG. 10A, wherein the historical oil production rate data 1010 is fitted to form a trend line 1025 for linear flow and a trend line 1035 for pseudo boundary stage flow. The trend line 1035 may be extended to an economic limit point 1045 where the trend line 1035 would intersect q_{oc}.

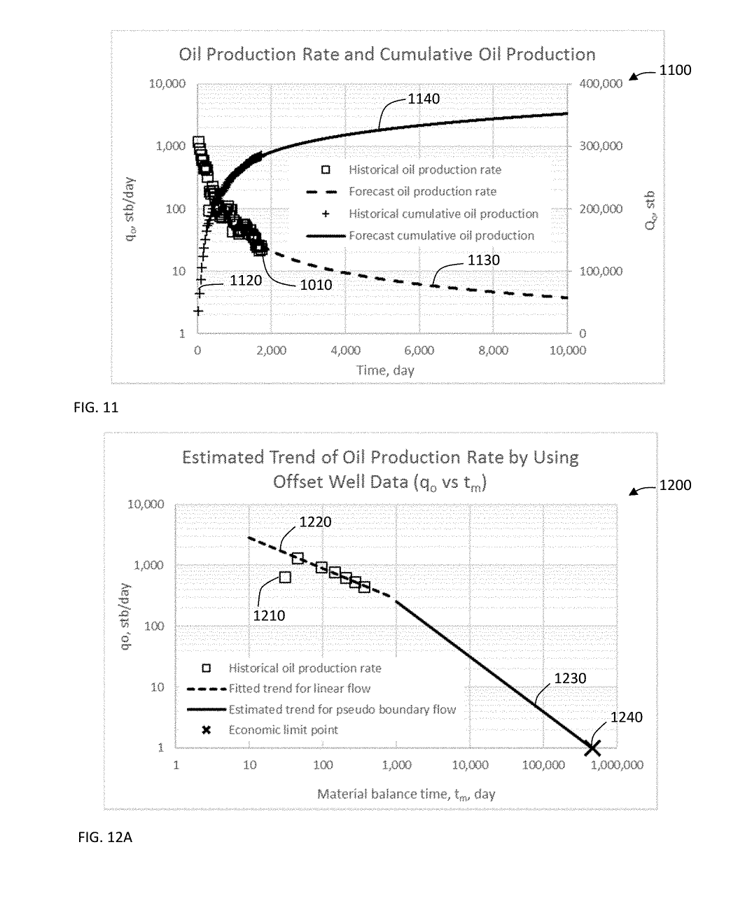

FIG. 11 shows a graph of a plot 1100 of another example of forecasted Qₒ and qₒ. Historical oil production rate data 1010 and cumulative oil production data 1120 are forecast and displayed as trend line 1130 and trend line 1140, respectively. The cumulative oil production and oil production rate are calculated by using the analytical solutions:

$$\begin{matrix}{Q}_{o} = {( {a}_{2} + 1 )}^{- ( {a}_{2} + 1 )} {10}^{{b}_{2}} {{X}_{0} [ 1 + ( t - {t}_{0} ) {X}_{0}^{- 1 / ( {a}_{2} + 1 )} ]}^{( {a}_{2} + 1 )} & ( 18 ) \\ {q}_{o} = {( {a}_{2} + 1 )}^{- {a}_{2}} {10}^{{b}_{2}} {{X}_{0}^{{a}_{2} / ( {a}_{2} + 1 )} [ 1 + ( t - {t}_{0} ) {X}_{0}^{- 1 / ( {a}_{2} + 1 )} ]}^{{a}_{2}} & ( 19 )\end{matrix}$$

### Where

Xₒ=(a₂+1)^{(a}^{₂}⁺¹⁾10^{-b}^{₂}Qₒ₀ (20)

Where Qₒ₀ is the last historical cumulative oil production, 284,949 stb.

But when the well production period is short and there is no pseudo boundary flow behavior has been identified based on the history of oil production, the offset well data for a longer term historical oil production that has already begun the stage of pseudo boundary flow stage is needed to estimate the transition time from the linear flow stage to pseudo boundary flow stage and the trend of pseudo boundary flow behavior, or a numerical reservoir model is needed to forecast the transition time and the trend of pseudo boundary flow stage.

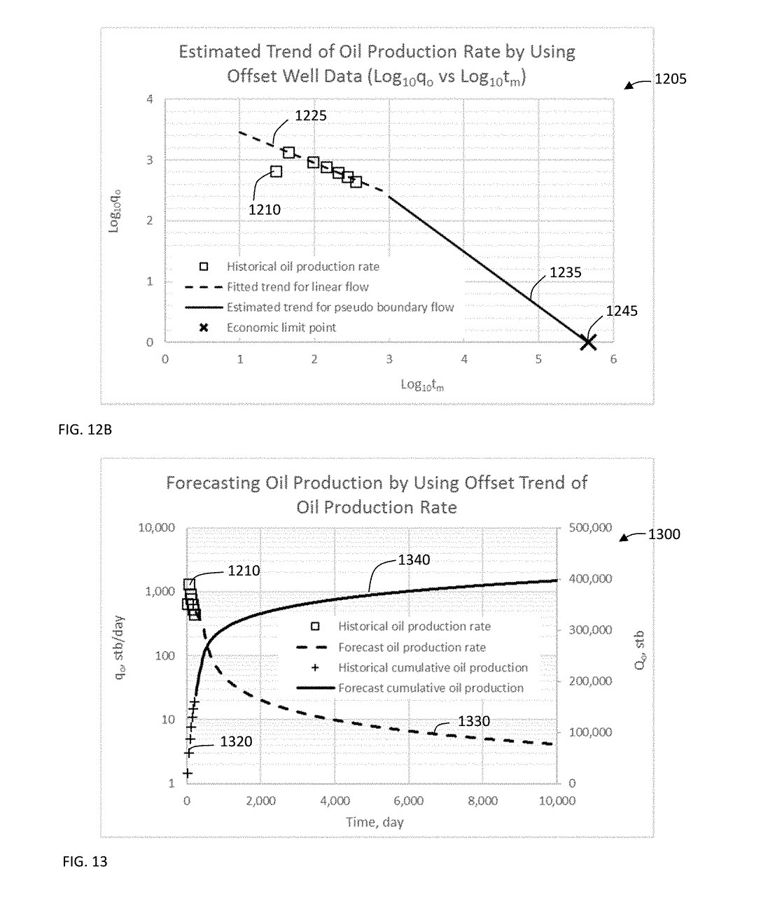

The example well used in the figures—FIG. 12A, FIG. 12B, and FIG. 13 has short time production history and only shows linear flow behavior, which is an offset well of the well used in the figures—FIG. 10A, FIG. 10B, and FIG. 11.

FIG. 12A shows a graph of a plot 1200 of the historical oil production data 1210 during linear flow. The production data 1210 is curve fit to a trend line 1220 representing the linear flow behavior. A second trend line 1230 represents a forecast of the pseudo boundary flow behavior, and the line 1230 may be extended to intersect q_{oc} at intersection 1240, which provides the t_{mb}. The transition time (material balance time), t_{mb}, from the above case is 750 days. The historical data for linear flow behavior is fitted by the function, log₁₀qₒ=a₁ log₁₀ tₘ+b₁, and the parameters a1 and b1 obtained from the fitting are −0.5 and 3.95, respectively. To keep the same t_{mb} (750 days), b₂ is adjusted to be 5.1. But a₂ is still kept as −0.9.

FIG. 12B shows a graph with a plot 1205 of the data and forecast from FIG. 12A shown in Log₁₀qₒ versus Log₁₀tₘ with linear scale. Herein, the oil production rate data 1210 is fitted with a trend line 1225 representing linear flow behavior. The forecast is a trend line 1235 to represent pseudo boundary flow behavior. The trend line 1235 may be extended to qₒ, to an intersection 1245 to determine t_{mc}. The q_{oc} is assumed as 1 stb/day. After extending the trend of qₒ during pseudo boundary flow stage until it reaches q_{oc}, the t_{mc} is obtained from FIG. 12A or FIG. 12B as 464,000 days. The EUR is calculated as 464,000 stb (Qₒ=t_{mc}×q_{oc}=1 stb/day×464,000 days=464,000 stb).

The real transition time, t_{b}, from linear flow stage to the pseudo boundary flow stage is calculated from the material transition time, t_{mb} by using the analytical solution:

t_{b}=t₀+t_{mb}(a₁+1)−X₀^{1/(a}^{₁}⁺¹⁾ (21)

Where

X₀=Qₒ₀(a₁+1)^{(a}^{₁}⁺¹⁾10^{-b}^{₁} (22)

FIG. 13 shows a graph of a plot 1300 that has historical oil production rate data 1210 and cumulative oil production data 1320 with corresponding forecast line 1330 and line 1340. The tₒ and Qₒ₀ are 211 days and 159,253 stb, respectively, and t_{mb} is 750 days. Combining with the fitted parameters for a₁, b₁, the t_{b} is calculated as 427 days. When t≤t_{b}, the cumulative oil production and oil production rate is calculated by the analytical solutions:

$$\begin{matrix}{Q}_{o} = {( {a}_{1} + 1 )}^{- ( {a}_{1} + 1 )} {10}^{{b}_{1}} {{X}_{0} [ 1 + ( t - {t}_{0} ) {X}_{0}^{- 1 / ( {a}_{1} + 1 )} ]}^{( {a}_{1} + 1 )} & ( 23 ) \\ {q}_{o} = {( {a}_{1} + 1 )}^{- {a}_{1}} {10}^{{b}_{1}} {{X}_{0}^{{a}_{1} / ( {a}_{2} + 1 )} [ 1 + ( t - {t}_{0} ) {X}_{0}^{- 1 / ( {a}_{1} + 1 )} ]}^{{a}_{1}} & ( 24 )\end{matrix}$$

When t>t_{b}, the cumulative oil production and oil production rate is calculated by the analytical solutions:

$$\begin{matrix}{Q}_{o} = {( {a}_{2} + 1 )}^{- ( {a}_{2} + 1 )} {10}^{{b}_{2}} {{X}_{b} [ 1 + ( t - {t}_{b} ) {X}_{b}^{- 1 / ( {a}_{2} + 1 )} ]}^{( {a}_{2} + 1 )} & ( 24 ) \\ {q}_{o} = {( {a}_{2} + 1 )}^{- {a}_{2}} {10}^{{b}_{2}} {{X}_{0}^{{a}_{2} / ( {a}_{2} + 1 )} [ 1 + ( t - {t}_{b} ) {X}_{b}^{- 1 / ( {a}_{2} + 1 )} ]}^{{a}_{2}} & ( 25 )\end{matrix}$$

### Where

X_{b}=Q_{ob}(a₂+1)^{(a}^{₂}⁺¹⁾10^{-b}^{₂} (26)

Where Q_{ob} is the cumulative production at the time t_{b} and can be calculated by the analytical solution:

$${Q}_{ob} = {( {a}_{1} + 1 )}^{- ( {a}_{1} + 1 )} {10}^{{b}_{1}} {{X}_{0} [ 1 + ( {t}_{b} - {t}_{0} ) {X}_{0}^{- 1 / ( {a}_{1} + 1 )} ]}^{( {a}_{1} + 1 )} \qquad ( 27 )$$

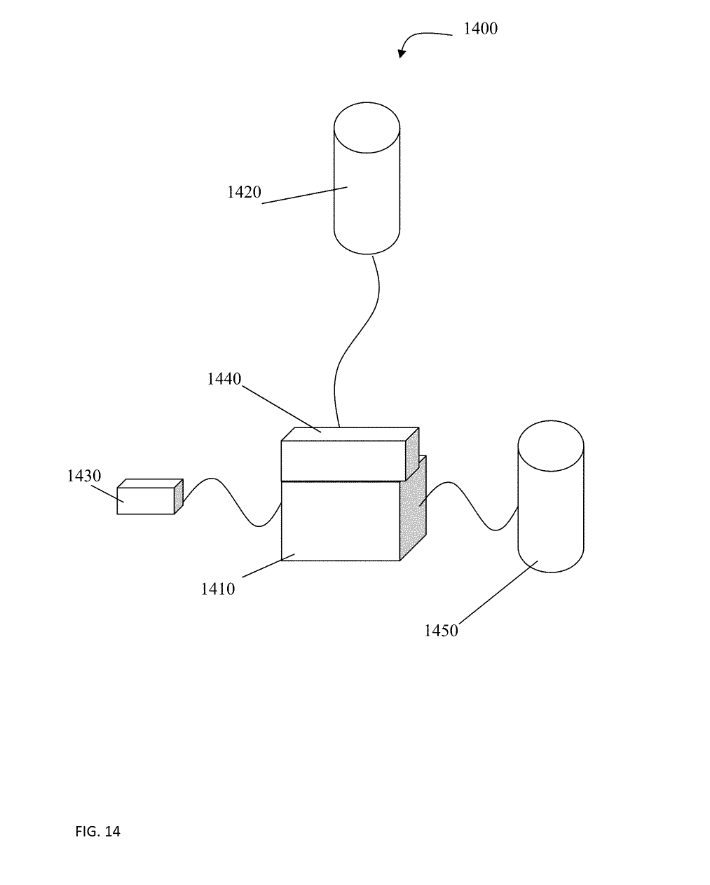

FIG. 14 shows a schematic of an exemplary hardware environment 1400 where the method may be implemented according to the present disclosure. The hardware environment may include an information processor 1410, a non-transitory computer-readable medium 1420, an input device 1430, a processor memory 1440, and may include peripheral information storage medium 1450. The hardware environment 1400 may be located in a single location or distributed across multiple locations. The input device 1430 may be any information reader or user input device, such as data card reader, keyboard, USB port, etc. The non-transitory computer-readable medium 1420 may be any standard non-transitory computer information storage device, such as a ROM, USB drive, memory stick, hard disk, removable RAM, EPROMs, EAROMs, EEPROM, flash memories, and optical disks or other commonly used memory storage system known to one of ordinary skill in the art including Internet based storage. The non-transitory computer-readable medium 1420 stores a program that when executed causes information processor 1410 to execute the disclosed method, such as exemplary methods 200 and 300. The non-transitory computer-readable medium 1420 may also store suitability data about the first party and/or suitability data about the plurality of insurance products. In some embodiments, the suitability data about the first party and/or the suitability data about the plurality of insurance products may be stored in a peripheral information storage medium 1450, which may be any standard computer information storage device, such as a USB drive, memory stick, hard disk, removable RAM, or other commonly used memory storage system known to one of ordinary skill in the art including Internet based storage. The information processor 1410 may be any form of computer or mathematical processing hardware, including Internet based hardware. When the program is loaded from the non-transitory computer-readable medium 1420 into processor memory 1440 (e.g. computer RAM), the program, when executed, causes information processor 1410 to retrieve the production/well data from either the non-transitory computer-readable medium 1420 or the peripheral information storage medium 1450 and to process the information to perform the forecast of oil production and/or EUR.

While the disclosure has been described with reference to exemplary embodiments, it would be understood that various changes may be made and equivalents may be substituted for elements thereof without departing from the scope of the disclosure. In addition, many modifications will be appreciated to adapt a particular instrument, situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A method for forecasting oil recovery from a first multiply-fractured horizontal oil well, the method comprising:
calculating a pressure drop; a pressure normalization rate; a cumulative oil production, and a material balance time for the well using historical oil production rate data, bottom hole pressure data, and an initial reservoir pressure for the first well;
generating a pressure normalization rate-material balance time curve of the historical oil production rate data;
determining if pseudo boundary flow stage behavior has started for the first well based on the pressure normalization rate-material balance time curve of the historical oil production rate data; where
if the pseudo boundary flow stage behavior has started:
generating a pressure normalization rate trend for a pseudo boundary flow stage of the first well; and
determining at least one of: an estimated ultimate recovery and a forecast of oil production for the first well; and where
if the pseudo boundary flow stage behavior has not started:
generating a pressure normalization rate trend for a linear flow stage of the first well;
obtaining offset well historical oil production rate data, offset well bottom hole pressure data, and offset well initial reservoir pressure data from a second well, offset from the first well;
calculating an offset well pressure drop; an offset well pressure normalization rate; an offset well cumulative oil production, and an offset well material balance time based on the offset well historical oil production rate data, the offset well bottom hole pressure data, and the offset well initial reservoir pressure data;
generating a pressure normalization rate-material balance time curve of offset well historical oil production rate;
generating a pressure normalization rate trend for the pseudo boundary flow stage using the offset well historical oil production rate data;
estimating a real transition time between the pressure normalization rate trend for the pseudo boundary flow stage and the pressure normalization rate trend for the linear flow stage; and
determining at least one of: estimated ultimate recovery and a forecast of oil production based on the offset well historical oil production rate data.

2. The method of claim 1, wherein determining estimated ultimate recovery comprises:
setting a critical production rate for the oil production rate;
estimating a maximum pressure drop of the first well;
extrapolating the pressure normalization rate trend for the pseudo boundary flow stage;
estimating a critical material balance time based on the extrapolated pressure normalization rate trend; and
estimating ultimate recovery for the first well based on the critical material balance time and the critical production rate.

3. The method of claim 1, wherein determining the forecast of oil production for the well comprises:
generating a pressure drop trend for the pseudo boundary flow stage;
determining a maximum pressure drop on the pressure drop trend; and
forecasting an oil production rate and a cumulative oil production value using the pressure drop trend at the maximum pressure drop.

4. The method of claim 1, wherein determining the forecast of oil production based on the offset well comprises:
generating a pressure drop trend for the pseudo boundary flow stage;
determining a maximum pressure drop on the pressure drop trend; and
forecasting an oil production rate and a cumulative oil production value using the pressure drop trend at the maximum pressure drop based on the offset well data.

5. The method of claim 1, further comprising:
obtaining the historical oil production rate data, the bottom hole pressure data, and the initial reservoir pressure data for the first well.

6. A system for forecasting oil recovery from a multiply-fractured horizontal oil well, the system comprising:
a processor;
data storage; and
instructions stored in the data storage that, when executed by the processor, cause the processor to:
calculating a pressure drop; a pressure normalization rate; a cumulative oil production, and a material balance time for the well using historical oil production rate data, bottom hole pressure data, and an initial reservoir pressure for the first well;
generating a pressure normalization rate-material balance time curve of the historical oil production rate data;
determining if pseudo boundary flow stage behavior has started for the first well based on the pressure normalization rate-material balance time curve of the historical oil production rate data; and where
if the pseudo boundary flow stage behavior has started:
generating a pressure normalization rate trend for a pseudo boundary flow stage of the first well; and
determining at least one of: an estimated ultimate recovery and a forecast of oil production for the first well; and where
if the pseudo boundary flow stage behavior has not started:
generating a pressure normalization rate trend for a linear flow stage of the first well;
obtaining offset well historical oil production rate data, offset well bottom hole pressure data, and offset well initial reservoir pressure data from a second well, offset from the first well;
calculating an offset well pressure drop; an offset well pressure normalization rate; an offset well cumulative oil production, and an offset well material balance time based on the offset well historical oil production rate data, the offset well bottom hole pressure data, and the offset well initial reservoir pressure data;
generating a pressure normalization rate-material balance time curve of offset well historical oil production rate;
generating a pressure normalization rate trend for the pseudo boundary flow stage using the offset well historical oil production rate data;
estimating a real transition time between the pressure normalization rate trend for the pseudo boundary flow stage and the pressure normalization rate trend for the linear flow stage; and
determining at least one of: estimated ultimate recovery and a forecast of oil production based on the offset well historical oil production rate data.

7. The system of claim 6, further comprising:
a flow sensor in fluid communication with the first well and configured to generate the historical oil production rate data;
a bottom hole pressure sensor disposed in the first well and configured to measure the bottom hole pressure of the first well; and
a pressure sensor in communication with a reservoir penetrated by the first well and configured to measure the initial reservoir pressure.

8. A method for forecasting oil recovery from a multiply-fractured horizontal oil well, the method comprising:
calculating a material balance time for the well using historical oil production rate data for the well;
generating an oil production rate-material balance time curve of the historical oil production rate data;
determining if pseudo boundary flow stage behavior has started for the first well based on the oil production rate-material balance time curve of historical oil production rate data; and where
if the pseudo boundary flow stage behavior has started:
generating an oil production rate trend for a pseudo boundary flow stage of the first well; and
determining at least one of: an estimated ultimate recovery and a forecast of oil production for the first well; and where
if the pseudo boundary flow stage behavior has not started:
generating an oil production rate trend for a linear flow stage of the first well;
obtaining offset well historical oil production rate data from a second well, offset from the first well;
calculating an offset well material balance time using the offset well historical oil production rate data;
generating an oil production rate-material balance time curve of offset well historical oil production rate;
generating an oil production rate trend for the pseudo boundary flow stage using the offset well historical oil production rate data;
estimating a real transition time between the oil production rate trend for the pseudo boundary flow stage and the oil production rate trend for the linear flow stage; and
determining at least one of: estimated ultimate recovery and a forecast of oil production for the first well.

9. The method of claim 8, wherein determining estimated ultimate recovery comprises:
setting a critical production rate for the oil production rate;
extrapolating the pressure normalization rate trend;
estimating a critical material balance time based on the extrapolated pressure normalization rate trend; and
estimating ultimate recovery for the first well based on the critical material balance time and the critical production rate

10. The method of claim 8, wherein determining the forecast of oil production for the well comprises:
forecasting an oil production rate and a cumulative oil production value using the pressure drop trend at the maximum pressure drop.

11. The method of claim 8, wherein determining the forecast of oil production based on the offset well comprises:
generating a pressure drop trend for the pseudo boundary flow stage;
determining a maximum pressure drop on the pressure drop trend; and
forecasting an oil production rate and a cumulative oil production value using the pressure drop trend at the maximum pressure drop based on the offset well data.

12. The method of claim 8, further comprising:
obtaining the historical oil production rate data, the bottom hole pressure data, and the initial reservoir pressure data for the first well.

13. A system for forecasting oil recovery from a multiply-fractured horizontal oil well, the system comprising:
a processor;
data storage;
instructions stored in the data storage that, when executed by the processor, cause the processor to:
calculating a material balance time for the well using historical oil production rate data for the well;
generating an oil production rate-material balance time curve of the historical oil production rate data;
determining if pseudo boundary flow stage behavior has started for the first well based on the oil production rate-material balance time curve of historical oil production rate data; and where
if the pseudo boundary flow stage behavior has started:
generating an oil production rate trend for a pseudo boundary flow stage of the first well; and
determining at least one of: an estimated ultimate recovery and a forecast of oil production for the first well; and where
if the pseudo boundary flow stage behavior has not started:
generating an oil production rate trend for a linear flow stage of the first well;
obtaining offset well historical oil production rate data from a second well, offset from the first well;
calculating an offset well material balance time using the offset well historical oil production rate data;
generating an oil production rate-material balance time curve of offset well historical oil production rate;
generating an oil production rate trend for the pseudo boundary flow stage using the offset well historical oil production rate data;
estimating a real transition time between the oil production rate trend for the pseudo boundary flow stage and the oil production rate trend for the linear flow stage; and
determining at least one of: estimated ultimate recovery and a forecast of oil production for the first well.

14. The system of claim 13, further comprising:
a flow sensor in fluid communication with the first well and configured to generate the historical oil production rate data;
